(19) United States
(12) Patent Application Publication
(10) Pub. No.: US 2020/0403879 A1
(43) Pub. Date: Dec. 24, 2020

(54) NETWORK DESIGN DEVICE, NETWORK DESIGN METHOD, AND NETWORK DESIGN PROCESSING PROGRAM

(71) Applicant: NIPPON TELEGRAPH AND TELEPHONE CORPORATION, Tokyo (JP)

(72) Inventors: Erina TAKESHITA, Musashino-shi, Tokyo (JP); Shinichi YOSHIHARA, Musashino-shi, Tokyo (JP); Hideo KAWATA, Musashino-shi, Tokyo (JP)

(73) Assignee: NIPPON TELEGRAPH AND TELEPHONE CORPORATION, Tokyo (JP)

(21) Appl. No.: 16/977,911

(22) PCT Filed: Feb. 28, 2019
(86) PCT No.: PCT/JP2019/007798

§ 371 Date: Sep. 3, 2020

(30) Foreign Application Priority Data
Mar. 7, 2018 (JP) 2018-041229

(51) Int. Cl. H04L 12/24; H04L 12/803

(52) U.S. Cl. CPC H04L 41/145; H04L 47/125; H04L 41/12

(57) ABSTRACT

With a network design apparatus, a network design method, and a network design processing program, a network configuration is designed for a network in which a transfer apparatus is disposed for each of a plurality of communication hubs and the communication hubs are connected via a link by a link portion apparatus in the transfer apparatus. In design of a network configuration, an optimal path candidate of each of the lines, an optimal link portion apparatus combination candidate of each link, and an optimal transfer apparatus combination candidate at each of the communication hubs minimizing a total cost value in an overall network are calculated on the basis of a path candidate set, an interface combination candidate set, and a combination candidate set of a transfer apparatus.

### TECHNICAL FIELD

Embodiments of the present invention relate to a network design apparatus, a network design method, and a network design processing program.

### BACKGROUND ART

In recent years, with the diversification of network services, the number of services has increased and requirements of a network for the services have diversified. Examples of the requirements for a network include an inter-end delay, band assurance, and conditions regarding redundancy. With the increase in the number of services or the diversification of the requirements, a cost of equipment of the network has increased.

In order to curb the increase in cost, for example, a network design in which a plurality of lines possessed by each network service are efficiently accommodated in a common infrastructure network is performed in NPL 1. Accordingly, economy of the network is further improved. In a method of NPL 1, an infrastructure network accommodating lines having different requirements for an inter-end delay is designed. Here, in the infrastructure network to be designed, a transfer apparatus that processes traffic of a path is disposed, and an interface is installed as a link portion apparatus in a link portion of the transfer apparatus. In NPL 1, a disposition and capacity of transfer apparatuses at which a total cost value of interfaces of all transfer apparatuses on the infrastructure network is minimized is derived in the design of the infrastructure network. Therefore, in the design of the infrastructure network, a design of a path accommodating each of the lines and equipment design for designing the disposition or capacity of the transfer apparatus on the infrastructure network are performed simultaneously.

An overall flow in a process performed in NPL 1 is illustrated in FIG. 1. In a design of a network as in NPL 1, each of the lines needs to be accommodated in a path satisfying requirements for an inter-end delay. Therefore, in S′1, path candidates satisfying the requirements for the inter-end delay are calculated for each of the lines, and a set of path candidates satisfying the requirements described above is a path candidate set, as illustrated in FIG. 1. The path candidate set consists of path candidates satisfying the requirements described above, and consists of a number of path candidates equal to or smaller than a designated number of path candidates. Here, the number of path candidates is a design parameter, and is designated by a designer.

Further, in NPL 1, interface combination candidates are calculated, and the calculated combination candidate set is used as an interface combination candidate set in S′2. In this case, combination candidates of interfaces that can be installed in the link portion of the transfer apparatus at each of the communication hubs on the infrastructure network are calculated. The combination candidate set includes combination candidates of interfaces that can be installed in the link portion by the designated number of interface combination candidates. Here, the number of combination candidates is a design parameter and is designated by a designer. Further, each of the interface combination candidates is a combination of zero or more interfaces. Further, certain interface combination candidates among the interface combination candidates may include the same type of interfaces.

In NPL 1, a total cost value of all the interfaces on the infrastructure network is used as an objective function, and an optimization problem in which an optimal network configuration for minimizing the objective function is derived is solved in S′3. A mathematical relationship obtained by formulating this optimization problem is shown below.

$$\begin{matrix}[ Math . 1 ] & \\ {arg min}_{\vec{x} , \vec{y}} 2 {\sum }_{e ∈ E} {\sum }_{j ∈ J} {y}_{j}^{e} \cdot {Ω}_{j}^{IF} \\ subject to , & {( 1 )}^{′} \\ \begin{matrix}{\sum }_{i ∈ {I}^{v}} {x}_{i}^{v} = 1 , & ∀ v ∈ V\end{matrix} & {( 2 )}^{′} \\ \begin{matrix}{\sum }_{j ∈ J} {y}_{j}^{e} = 1 , & ∀ e ∈ E\end{matrix} & {( 3 )}^{′} \\ \begin{matrix}{y}_{j}^{e} \cdot {Ψ}_{j}^{IF} \geq {t}^{e} ( \vec{x} , \vec{d} , M ) & ∀ e ∈ E\end{matrix} & {( 4 )}^{′}\end{matrix}$$

Further, matters indicated by, for example, parameters relevant to the relationship (1)′ to (4)′ are as follows.

[Math. 2]

L=(l) Set of Communication hubs
E=(e): Set of Links between Communication hubs
V=(V): Set of lines
\vec{x}=(xᵢ^{v}): Line v selects path candidate i
\vec{y}=(yⱼ^{e}): Link e selects Interface (IF) combination candidate j
Ωⱼ^{IF}: Cost value of IF combination candidate j
I^{v}: Path candidate set of line v
J: IF Combination candidate set
Ψ_{J}^{IF}: Capacity of IF combination candidate j
\vec{d}=(dᵥ): Contracted band of line v
M: Connection Matrix (indicted by |L| X |E|) indicating connection form between communication hubs t^{e}(\vec{x}, \vec{d}, M): Sum of contracted Bands of Link e (calculated on basis of \vec{x}, \vec{d}, M)

In the optimization problem of S′3, one path candidate is selected from the path candidate set for each of the lines. For each of the lines, a condition for selecting the path candidate from the path candidate set is shown in the relationship (2)′. Here, in the relationship (1)′ to (4)′, a variable x is a decision variable of the optimization problem. In each of the lines, the variable x changes in correspondence to which path candidate has been selected from the path candidate set. Further, in the optimization problem, one combination candidate for a combination of interfaces is selected from the interface combination candidate set, for each link portion of the transfer apparatus, that is, for each link connecting each of the communication hubs. For each link portion, a condition for selecting an interface combination candidate from a combination candidate set is shown in the relationship (3)′. Here, in the relationship (1)′ to (4)′, a variable y is a decision variable of the optimization problem. In each link portion, the variable y changes in correspondence to which interface combination candidate has been selected from the combination candidate set.

Further, in the optimization problem of S′3, capacity conditions of the relationship (4)′ are provided. That is, in each link (each link portion), a total contracted band being equal to or smaller than a total capacity of all interfaces constituting the combination candidates is provided as the capacity conditions. Therefore, in the optimization problem, a combination candidate selected from an interface combination candidate set needs to satisfy the capacity conditions described above in each link.

In S′3, a total cost value of all interfaces on an infrastructure network shown in the relationship (1)′ is used as an objective function, and an optimization problem for minimizing the objective function is solved. By solving the optimization problem, an optimal path candidate is determined from the path candidates satisfying the conditions of the relationship (2)′ to (4)′, and an optimal combination candidate is determined from the interface combination candidates satisfying the conditions of the relationship (2)′ to (4)′.

In NPL 1, because the process is performed as described above, a network configuration with a smallest total cost value, that is, an optimal network configuration can be derived in an infrastructure network accommodating lines having different requirements for an inter-end delay. That is, for a network configuration including a path accommodating lines, and a disposition and capacity of each of transfer apparatuses and link portion apparatuses, an optimal network configuration can be derived from among a plurality of patterns.

### CITATION LIST

### Non Patent Literature

NPL 1: Erina Takeshita and Hideo Kawada, “ [symbol] [symbol] [symbol] [symbol] (Proposed Network Design Scheme Accommodating Various Paths)”, Electronics, Information and Communication Engineers General Conference B-6-29, 2017.

### SUMMARY OF THE INVENTION

### Technical Problem

In NPL 1, an optimal network configuration for minimizing a sum of the cost values of the interfaces is derived by taking a cost values of all the interfaces installed in the link portion of the transfer apparatus into account. In this case, a total contracted band of each link is calculated on the basis of the path candidates selected for each of the lines. In an optimal interface combination candidate calculated in each link, a total capacity of a plurality of interfaces installed in the link portion is equal to or greater than a calculated total contracted band. Accordingly, the number of interfaces to be disposed in the link portion of the transfer apparatus is not limited in the derivation of the optimal network configuration. Further, the number and capacity of the transfer apparatuses in which the interfaces are installed are not also limited.

However, in the overall infrastructure network, a cost is also generated due to the transfer apparatus in which the interfaces are installed. Thus, even when the total cost value of the interfaces is minimized in the derived optimal network configuration, a cost value in the overall infrastructure network may not be a minimum value depending on the disposition of the transfer apparatuses and the capacity of the transfer apparatuses to be disposed.

The present invention has been made with reference to the above circumstances, and provides a network design apparatus, a network design method, and a network design processing program capable of designing an optimal network configuration taking a cost of a transfer apparatus into account in calculation of an optimization problem.

### Means for Solving the Problem

To achieve the above object, a first aspect of the present invention is a network design apparatus for designing a network configuration for a network in which a transfer apparatus is disposed for each of a plurality of communication hubs and the communication hubs are connected via a link by a link portion apparatus in the transfer apparatus, the network design apparatus comprising: an input reception unit configured to receive an input of topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design; a first processing unit including a calculation unit configured to calculate a path candidate set of each of the lines on the basis of the topology information, the line information, and the design parameter information; a second processing unit including a first calculation unit configured to calculate a combination candidate set of the link portion apparatuses on the basis of the apparatus information and the design parameter information, and a second calculation unit configured to calculate a combination candidate set of the transfer apparatuses on the basis of the apparatus information and the design parameter information; a third processing unit including a calculation unit configured to calculate, minimizing a total cost value in the overall network, an optimal path candidate of each of the lines, an optimal combination candidate of the link portion apparatus of each link, and an optimal combination candidate of the transfer apparatus at each of the communication hubs on the basis of a calculation result of the calculation unit of the first processing unit, a calculation result of the first calculation unit of the second processing unit, and a calculation result of the second calculation unit of the second processing unit; and a generation unit configured to generate network configuration information reflecting the optimal path candidate of each of the lines, the optimal combination candidate of the link portion apparatus of each link, and the optimal combination candidate of the transfer apparatus at each of the communication hubs calculated by the calculation unit of the third processing unit.

A second aspect of the present invention is the network design apparatus according to the first aspect, wherein the calculation unit of the third processing unit uses a sum of a total cost value of the link portion apparatuses in the overall network and a total cost value of the transfer apparatuses in the overall network as a total cost value in the overall network.

A third aspect of the present invention is the network design apparatus according to the second aspect, wherein the second calculation unit of the second processing unit calculates the combination candidate set of the transfer apparatuses with a different total number of slots of the transfer apparatuses for each combination candidate, and the calculation unit of the third processing unit calculates a total number of link portion apparatuses at each of the communication hubs on the basis of the selected path candidate of each of the lines and the selected combination candidate of the link portion apparatuses for each link, and calculates an optimal combination candidate of the transfer apparatuses at each of the communication hubs on condition that the total number of slots of the transfer apparatus in the derived combination candidate is equal to or greater than the calculated total number of the link portion apparatuses for each of the communication hubs.

A fourth aspect of the present invention is a network design processing program for causing a processor to function as each unit of the network design apparatus according to any one of the first to third aspects.

A fifth aspect of the present invention is a network design method for designing a network configuration for a network in which a transfer apparatus is disposed for each of a plurality of communication hubs and the communication hubs are connected via a link by a link portion apparatus in the transfer apparatus, the network design method comprising: acquiring topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design; calculating a path candidate set of each of the lines on the basis of the topology information, the line information, and the design parameter information; calculating a combination candidate set of the link portion apparatuses on the basis of the apparatus information and the design parameter information; calculating a combination candidate set of the transfer apparatuses on the basis of the apparatus information and the design parameter information; calculating, minimizing a total cost value in the overall network, an optimal path candidate of each of the lines, an optimal combination candidate of the link portion apparatus of each link, and an optimal combination candidate of the transfer apparatus at each of the communication hubs on the basis of a calculation result for the path candidate set of each of the lines, a calculation result for the combination candidate set of the link portion apparatus, and a calculation result for the combination candidate set of the transfer apparatus; and generating network configuration information reflecting the calculated optimal path candidate of each of the lines, the calculated optimal combination candidate of the link portion apparatus of each link, and the calculated optimal combination candidate of the transfer apparatus at each of the communication hubs.

### Effects of the Invention

According to the first to fifth aspects of the present invention, in an optimization problem for calculating an optimal network configuration minimizing a total cost value in the overall network, the optimal path candidate, the optimal combination candidate of the link portion apparatuses, and the optimal combination candidate of the transfer apparatuses are calculated on the basis of the combination candidate set of transfer apparatuses at each of the communication hubs, in addition to the path candidate set of each of the lines and the combination candidate set of link portion apparatuses of each link. This allows the cost of the transfer apparatus to be taken into account in calculating the optimization problem, and allows a network design apparatus, a network design method, and a network design processing program capable of designing an optimal network configuration to be provided.

Further, in the second and third aspects of the present invention, a sum of the cost of the link portion apparatus and the cost of the transfer apparatus is used as the objective function of the optimization problem in the calculation of the optimization problem. Thus, in the optimization problem, the optimal path candidate, the optimal combination candidate of the link portion apparatuses, and the optimal combination candidate of the transfer apparatuses taking the cost of the transfer apparatuses into account are derived more appropriately.

Further, in the third aspect of the present invention, an optimal combination of the transfer apparatuses at each of the communication hubs is derived so that conditions regarding the capacity of the slots of each transfer apparatus are satisfied. Thus, in the optimization problem, the optimal path candidate, the optimal combination candidate of the link portion apparatuses, and the optimal combination candidate of the transfer apparatuses are derived more appropriately.

### BRIEF DESCRIPTION OF DRAWINGS

FIG. 1 is a flowchart illustrating an overall flow in a process performed in NPL 1.

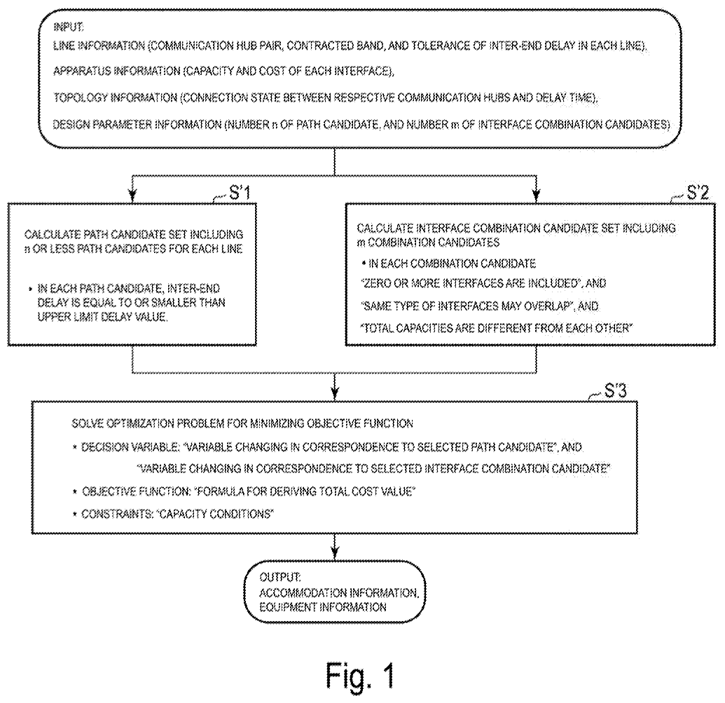

FIG. 2 is a block diagram illustrating an example of a network design apparatus according to a first embodiment of the present invention.

FIG. 3 is a flowchart illustrating an operation example procedure of the network design apparatus according to the first embodiment.

FIG. 4 is a flowchart illustrating an example of a procedure for calculating a path candidate set for any line in the first embodiment.

FIG. 5 is a flowchart illustrating an example of a procedure for calculating an interface combination candidate set in the first embodiment.

FIG. 6 is a flowchart illustrating an example of a procedure for calculating a switch combination candidate set in the first embodiment.

FIG. 7 is a schematic diagram illustrating an example of a topology in an operation example in the first embodiment.

FIG. 8 is a schematic diagram illustrating a model example for use in the example of the topology of FIG. 6.

FIG. 9 is a schematic diagram illustrating an example of a switch in the operation example in the first embodiment.

FIG. 10 is a schematic diagram illustrating an example of disposition of switches in an infrastructure network illustrated in FIG. 7.

FIG. 11 is a schematic diagram illustrating an example of an optimal disposition example in a network in the operation example in the first embodiment.

FIG. 12 is a schematic diagram illustrating an example of an optimal disposition example of a network in a comparative example.

### DESCRIPTION OF EMBODIMENTS

Hereinafter, embodiments of the present invention will be described with reference to the drawings. An L2 switch is used as an example of a network apparatus in each embodiment. As a transfer apparatus, any network apparatus can be used as long as the network apparatus is an apparatus in which a link portion apparatus such as an interface can be installed as equipment within the network apparatus, in addition to the L2 switch. For example, in each embodiment, a router or the like is available as the network apparatus (transfer apparatus).

### First Embodiment

In a first embodiment, a cost of a transfer apparatus is also taken into account as a cost of an infrastructure network, in addition to a cost of an interface. This allows a network configuration with a smaller cost value to be derived.

Apparatus

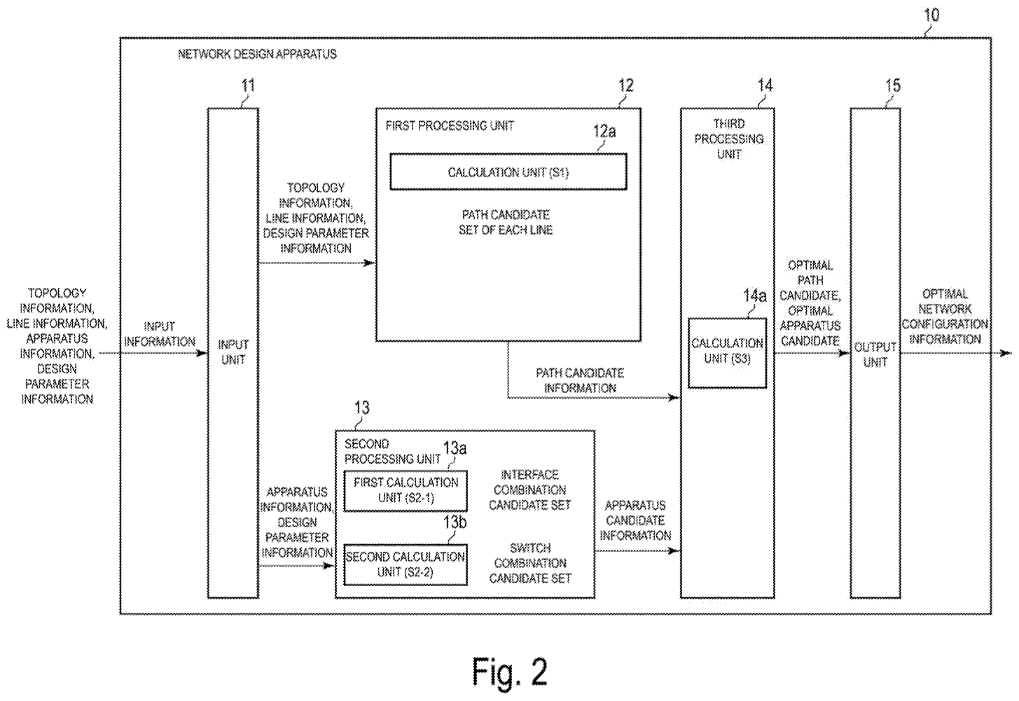

An example of a network design apparatus of the first embodiment is shown. FIG. 2 is a diagram illustrating an example of the network design apparatus according to the first embodiment of the present invention. The network design apparatus 10 outputs optimal network configuration information including optimal path information and optimal equipment information on the basis of input information. The network design apparatus 10 includes an input unit (input reception unit) 11, a first processing unit 12, a second processing unit 13, a third processing unit 14, and an output unit (generation unit) 15.

The first processing unit 12 includes a calculation unit 12a. The second processing unit 13 includes a first calculation unit 13a and a second calculation unit 13b. The third processing unit 14 includes a calculation unit 14a.

An input unit 11, which is an input reception unit, has a function of receiving input information input by a network designer, and outputting the input information to the first processing unit 12 and the second processing unit 13. The input information includes topology information, line information, apparatus information, and design parameter information. The topology information is information on a connection state between communication hubs on the infrastructure network. The line information is information on a plurality of lines accommodated in a network, and the plurality of lines are possessed by each network service. The apparatus information is information on a transfer apparatus disposed at each of the communication hubs on the infrastructure network. Further, the apparatus information also includes information on a link portion apparatus such as an interface, which is installed on each transfer apparatus. The design parameter information is information on parameters that are used in design of a network.

The information including the topology information, the line information, and the design parameter information is input from the input unit 11 to the calculation unit 12a. The calculation unit 12a calculates a path candidate set from the information input from the input unit 11. The calculation unit 12a calculates the path candidate set of each of the lines. The first processing unit 12 outputs the path candidate information including the path candidate set obtained by the calculation unit 12a. The path candidate information is output to the third processing unit 14.

Information including the apparatus information and the design parameter information is input from the input unit 11 to the first calculation unit 13a. The first calculation unit 13a calculates an interface combination candidate set from the information input from the input unit 11.

The information including the apparatus information and the design parameter information is input from the input unit 11 to the second calculation unit 13b. The second calculation unit 13b calculates a switch combination candidate set from the information input from the input unit 11.

The second processing unit 13 outputs apparatus candidate information. The apparatus candidate information is output to the third processing unit 14. An apparatus candidate set includes the interface combination candidate set obtained by the first calculation unit 13a and the switch combination candidate set obtained by the second calculation unit 13b.

The path candidate information is input from the first processing unit 12 to the calculation unit 14a, and the apparatus candidate information is input from the second processing unit 13 to the calculation unit 14a. The calculation unit 14a calculates an optimal path candidate and an optimal apparatus candidate from the path candidate information and the apparatus candidate information to be input. The optimal apparatus candidate includes an optimal switch combination candidate and an optimal interface combination candidate. The third processing unit 14 outputs the optimal path candidate and the optimal apparatus candidate obtained by the calculation unit 14a to the output unit 15.

The optimal path candidate and the optimal apparatus candidate are input from the third processing unit 14 to the output unit 15, which is a generation unit. The output unit 15 generates network configuration information reflecting both the optimal path candidate and the optimal apparatus candidate on the basis of the information input from the third processing unit 14. The output unit 15 outputs the network configuration information reflecting the optimal path candidate and the optimal apparatus candidate, as optimal network configuration information, to a terminal apparatus to be operated by the network designer. The optimal network configuration information includes information on an optimal path accommodating each of the lines and optimal equipment information regarding a switch and an interface disposed at each of the communication hubs. The optimal equipment information regarding switches includes information on an optimal disposition of the switches and an optimal capacity of the switches. The optimal equipment information regarding interfaces includes information on an optimal disposition of the interfaces and an optimal capacity of the interfaces. The output unit (generation unit) 15 may store the generated optimal network configuration information in a recording medium or the like instead of outputting the optimal network configuration information to the terminal apparatus or the like.

Input Information

In the first embodiment, an example of the input information input to the input unit 11 of the network design apparatus 10 is shown. The input information is information input to the input unit 11 by a network designer. The input information that the network designer inputs to the input unit 11 of the network design apparatus 10 includes: (1) the topology information; (2) the line information; (3) the apparatus information; and (4) the design parameter information.

(1) The topology information includes (1-1) a connection matrix indicating a connection state between the communication hubs in the infrastructure network, and (1-2) a delay time in a link between the communication hubs.

(2) The line information includes (2-1) a starting point and an ending point of communications in each of the lines, (2-2) a contracted band in each of the lines, and (2-3) a tolerance of the inter-end delay in each of the lines. (2-1) The starting point and the ending point of the communication in each of the lines indicates a pair of communication hubs serving as end points of the line.

(3) The apparatus information includes information on each switch and information on each interface. Each interface constitutes a link portion apparatus in a switch disposed at the communication hub. The apparatus information includes (3-1) the number of slots of each switch, (3-2) a cost value of each switch, (3-3) a traffic capacity of each interface, and (3-4) a cost value of each interface.

(4) The design parameter information includes (4-1) the number of path candidates (an upper limit value of the number of path candidates) per line, (4-2) the number of switch combination candidates (a design value of the number of switch combination candidates), and (4-3) the number of interface combination candidates (a design value of the number of interface combination candidates).

Overview of Overall Flow and Each Process

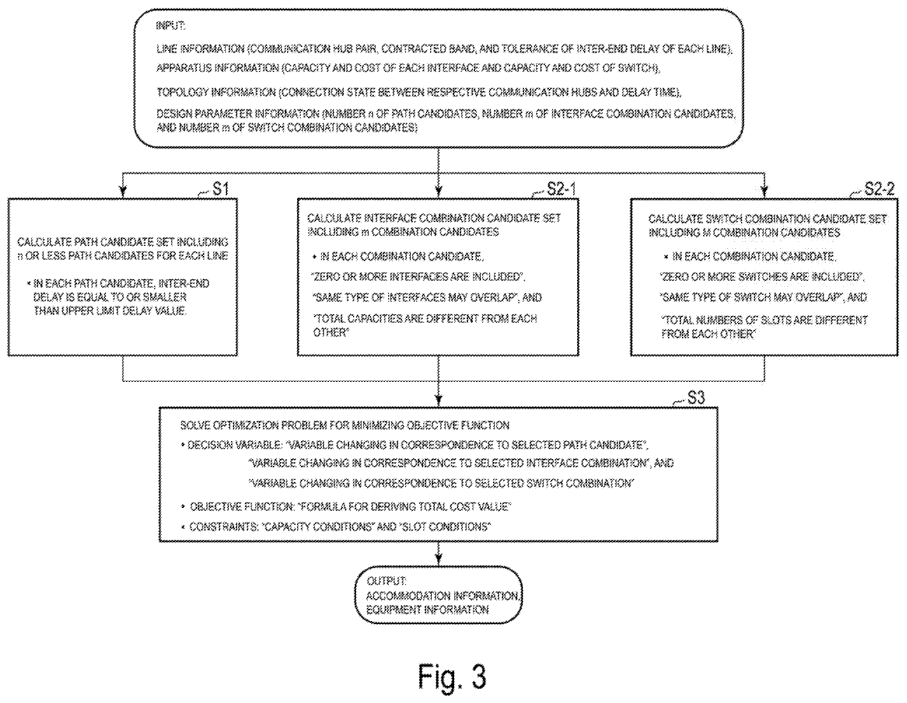

FIG. 3 is a flowchart illustrating an operation example procedure of the network design apparatus according to the first embodiment.

In S1, the calculation unit 12a of the first processing unit 12 calculates the path candidate set of each of the lines. In S1, the calculation unit 12a calculates, for each of the lines, an upper limit delay value, which is a threshold value for an inter-end delay. The calculation unit 12a calculates the path candidate set on the basis of the calculated upper limit delay value.

In S2-1, the first calculation unit 13a of the second processing unit 13 calculates an interface combination candidate set.

In S2-2, the second calculation unit 13b of the second processing unit 13 calculates a switch combination candidate set.

S3 is performed on the basis of calculation results in S1, S2-1, and S2-2 after S1, S2-1, and S2-2. In S3, the calculation unit 14a of the third processing unit 14 calculates an optimal path for accommodating each of the lines, a combination candidate for an optimal switch disposed at each of the communication hubs, and a combination candidate for an optimal interface disposed in the switch at each of the communication hubs. The optimal network configuration is calculated on the basis of the optimal path candidates, the optimal switch combination candidates, and the optimal interface combination candidates, that is, on the basis of calculation results in S3.

Details of Each Process

Next, details of S1 to S3 will be described.

### Calculation of Path Candidate Set (S1)

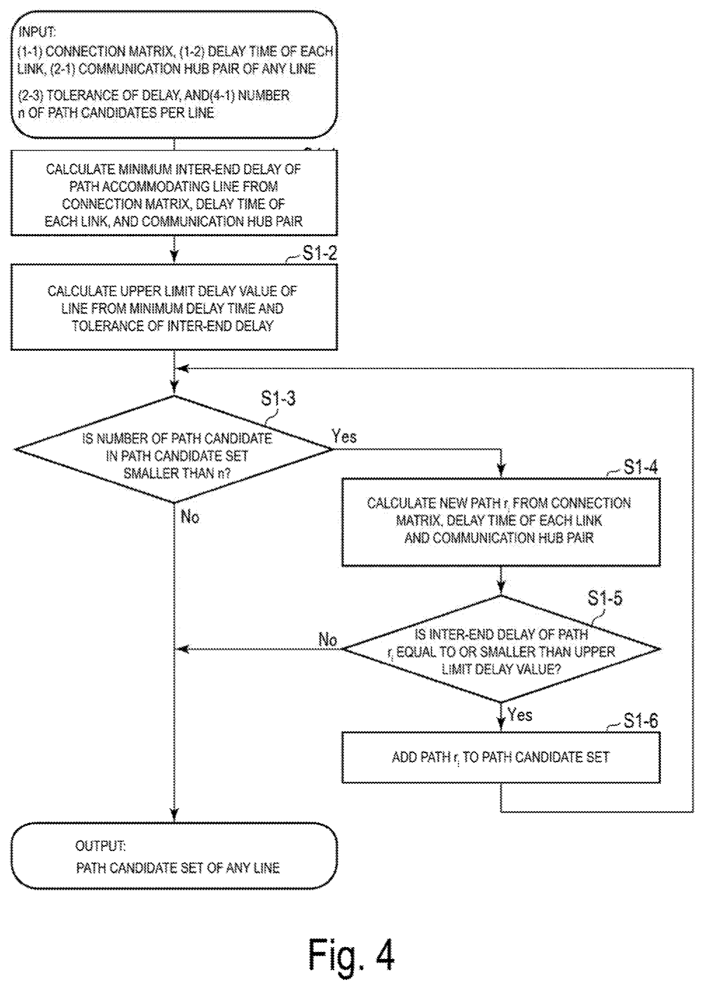

In the calculation of the path candidate set (S1), the calculation unit 12a of the first processing unit 12 calculates, for each of the lines, an upper limit delay value, which is a threshold value of an inter-end delay, and the path candidate set. The upper limit delay value and the path candidate set are calculated from (1-1) the connection matrix, (1-2) the delay time of each link, (2-1) a communication hub pair, (2-3) the tolerance of the inter-end delay, and (4-1) the number of path candidates per line described above. FIG. 4 is a flowchart illustrating an example of a procedure for calculating a path candidate set for any line.

First, in S1-1, the calculation unit 12a of the first processing unit 12 calculates a minimum inter-end delay for a path accommodating any line. The minimum inter-end delay is a minimum value of the inter-end delay of the path accommodating the line. The calculation unit 12a calculates the minimum inter-end delay from (1-1) the connection matrix, (1-2) the delay time of each link, and (2-1) the communication hub pair of the line described above. For example, the calculation unit 12a creates a weighted undirected graph from (1-1) the connection matrix and (1-2) the delay time of each link. The calculation unit 12a calculates a shortest path and a sum of weights of the links in the shortest path in the created weighted undirected graph using a Dijkstra method. In this case, the sum of the weights of the links in the shortest path is calculated as the minimum inter-end delay.

Next, in S1-2, the calculation unit 12a of the first processing unit 12 calculates an upper limit delay value of the line. The calculation unit 12a calculates the upper limit delay value of the line from the minimum inter-end delay calculated in S1-1 and (2-3) the tolerance of the inter-end delay of the line. For example, when the minimum inter-end delay 1 and a numerical value i indicating the tolerance of the inter-end delay of the line have been defined, the calculation unit 12a performs calculation using 1×i as a calculation relationship for the upper limit delay value. The numerical value indicating the tolerance of the inter-end delay described above and a setting of the calculation relationship for the upper limit delay value are examples, and any value or calculation relationship can be set according to the embodiment. Accordingly, the upper limit delay value according to the tolerance of the inter-end delay can be calculated.

Next, in S1-3, the calculation unit 12a of the first processing unit 12 performs a determination from (4-1) the number n of path candidates per line. That is, the calculation unit 12a determines whether the number of path candidates already included in the path candidate set is smaller than n. When the number of path candidates already included in the path candidates is smaller than n (S1-3: Yes), the process proceeds to S1-4. On the other hand, when the number of path candidates already included in the path candidate set is n or greater (S1-3: No), the first processing unit 12 outputs the path candidate set including the already calculated path candidates. The process of S1 ends.

In S1-4, the calculation unit 12a of the first processing unit 12 calculates anew path rᵢ. In this case, the calculation unit 12a calculates the new path rᵢ from (1-1) the connection matrix, (1-2) the delay time of each link, and (2-1) the pair of communication hubs. Here, the calculation unit 12a calculates the new path in ascending order of the inter-end delay each time the process of S1-4 is repeated. In this case, a new path is calculated using a k-shortest path algorithm (see a reference “Jin Y Yen,” Finding the K Shortest Loopless Paths in a Network”, Management Science, vol. 17, No. 11, pp. 712-716, 1971”). For example, it is assumed that a weighted graph G, a starting point s, and an ending point t have been assigned. In the k-shortest path algorithm, k paths that do not include a loop from s to t are searched for in ascending order of cost. Accordingly, in S1-4, the calculation unit 12a calculates the new path in ascending order of the inter-end delay using the k-shortest path algorithm.

Next, in S1-5, the calculation unit 12a of the first processing unit 12 calculates the inter-end delay of the path rᵢ calculated in S1-4. The calculation unit 12a determines whether the calculated inter-end delay is equal to or smaller than the upper limit delay value calculated in S1-2. When the inter-end delay of the new path rᵢ is equal to or smaller than the upper limit delay value (S1-5: Yes), the process proceeds to S1-6. On the other hand, when the inter-end delay of the new path rᵢ is greater than the upper limit delay value (S1-5: No), the first processing unit 12 outputs the path candidate set including the already calculated path candidate. Thus, the new path rᵢ calculated in S1-4 is not included in the path candidate set.

Next, the calculation unit 12a of the first processing unit 12 adds the path rᵢ calculated in S1-4 to the path candidate set as one path candidate in S1-6. The process returns to S1-3.

By S1-3 to S1-6 being performed as described above, the new path rᵢ is added to the path candidate set as the path candidate as long as the number of path candidates in the path candidate set are smaller than n and the inter-end delay of the new path rᵢ is equal to or smaller than the upper limit delay value. Thus, in the path candidate set of any line output in S1, the number of path candidates is equal to or smaller than n, and the inter-end delay of each path candidate is equal to or smaller than the upper limit delay value of the line. Here, n is the number of path candidates per line (an upper limit value of the number of path candidates), and is input by the network designer, as described above.

In the embodiment, the path candidate set is calculated in each of the lines using the procedure of S1 described above. The path candidate set of each of the lines calculated in S1 is used as an input of S3.

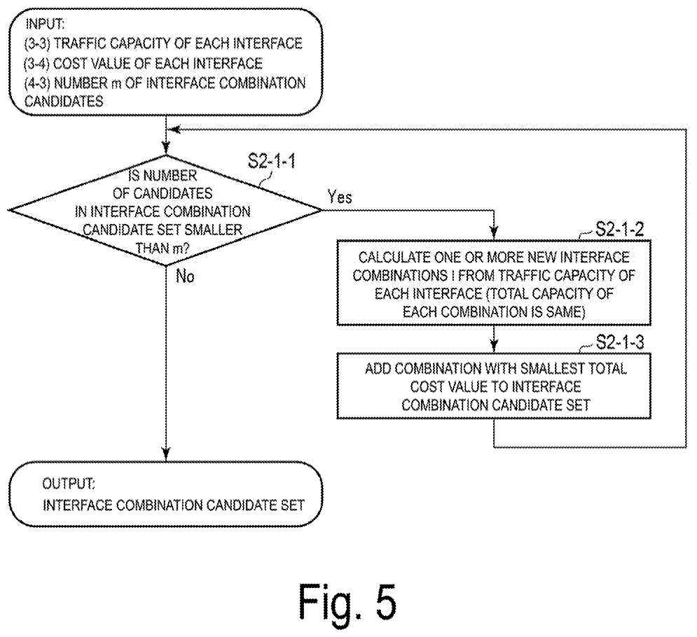

Calculation of Interface Combination Candidate Set (S2-1) In calculation of an interface combination candidate set (S2-1), the first calculation unit 13a of the second processing unit 13 calculates the interface combination candidate set. The first calculation unit 13a calculates the interface combination candidate set from (3-3) the traffic capacity of each interface and (4-3) the number m of interface combination candidates. The calculated interface combination candidate set includes m combination candidates for an interface combination. Each combination candidate is a combination of zero or more interfaces, and in each combination candidate, a plurality of interfaces with the same traffic capacity may be overlapped and combined. Each combination candidate also includes a combination in which there is no interface used. FIG. 5 is a flowchart illustrating an example of a procedure for calculating the interface combination candidate set.

First, in S2-1-1, the first calculation unit 13a of the second processing unit 13 performs a determination from (4-3) the number m of interface combination candidates. That is, the first calculation unit 13a determines whether the number of combination candidates already included in the interface combination candidate set is smaller than m. When the number of combination candidates already included in the combination candidate set is smaller than m (S2-1-1: Yes), the process proceeds to S2-1-2. On the other hand, when the number of candidates already included in the combination candidate set is equal to or greater than m (S2-1-1: No), the second processing unit 13 outputs the interface combination candidate set including the already calculated combination candidates.

Next, in S2-1-2, the first calculation unit 13a of the second processing unit 13 calculates one or more new interface combinations I. The first calculation unit 13a calculates the new combination I from (3-3) the traffic capacity of each interface. In this case, the first calculation unit 13a may calculate a plurality of new combinations I. In the plurality of new combinations I to be calculated, however, total capacities, which are the sums of the traffic capacities of the interfaces, are the same as each other. Further, each new combination I to be calculated is a combination of zero or more interfaces, and in each combination I, a plurality of interfaces of the same type are allowed to overlap. The interfaces with the same traffic capacities correspond to the same types of interfaces. Further, each time the process of S2-1-2 is repeated, the first calculation unit 13a calculates the new combination I in ascending order of the total capacity of the interfaces included in the combination.

Next, in S2-1-3, the first calculation unit 13a of the second processing unit 13 selects one of the new combinations I calculated in S2-1-2 from (3-4) the cost value of each interface. In this case, the first calculation unit 13a selects one combination in which a total cost value that is a sum of the cost values of the interfaces is smallest, from among the combinations I. The first calculation unit 13a adds the one combination selected from among the combinations I to the interface combination candidate set.

By S2-1-1 to S2-1-3 being performed as described above, m combination candidates are included in the interface combination candidate set output in S2-1, and total capacities of the respective combination candidates are prime to each other. That is, the m combination candidates included in the interface combination candidate set differ in the total capacity of the interfaces. Further, each combination candidate is a combination of zero or more interfaces, and in each combination candidate, a plurality of interfaces of the same type are allowed to be overlap. Further, each combination candidate has a candidate number. The candidate number is set to a natural number between 1 and m. When the candidate number becomes greater, the total capacity of the interfaces included in the combination increases.

In the embodiment, the interface combination candidate set is calculated using the procedure of S2-1 described above. The interface combination candidate set calculated in S2-1 is used as an input of S3.

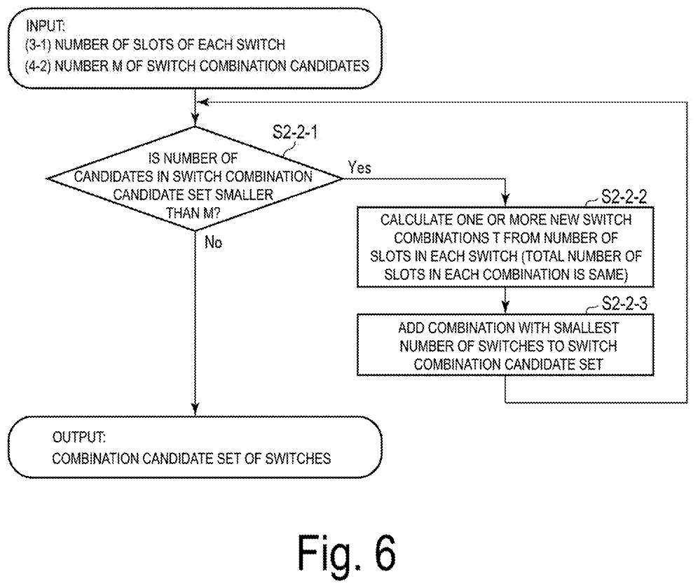

Calculation of Switch Combination Candidate Set (S2-2) In the calculation of the switch combination candidate set (S2-2), the second calculation unit 13b of the second processing unit 13 calculates a switch combination candidate set. The second calculation unit 13b calculates the switch combination candidate set from (3-1) the number of slots of each switch and (4-2) the number M of switch combination candidates. The switch combination candidate set to be calculated includes M combination candidates for a switch combination. Each combination candidate is a combination of zero or more switches, in each combination candidate, a plurality of switches with the same number of slots may be combined. Each combination candidate also includes a combination in which the number of switches to be used is 0. FIG. 6 is a flowchart illustrating an example of a procedure for calculating a switch combination candidate set.

First, in S2-2-1, the second calculation unit 13b of the second processing unit 13 performs a determination from (4-2) the number M of switch combination candidates. That is, the second calculation unit 13b determines whether the number of combination candidates already included in the switch combination candidate set is smaller than M. When the number of combination candidates already included in the combination candidate set is smaller than M (S2-2-1: Yes), the process proceeds to S2-2-2. On the other hand, when the number of combination candidates already included in the combination candidate set is equal to or greater than M (S2-2-1: No), the second processing unit 13 outputs the already calculated interface combination candidate set.

Next, the second calculation unit 13b of the second processing unit 13 calculates one or more new switch combinations T in S2-2-2. The second calculation unit 13b calculates the new combination T from (3-1) the number of slots of each switch. In this case, the second calculation unit 13b may calculate a plurality of new combinations T. In the plurality of new combinations T to be calculated, however, the total numbers of slots, which are sums of the numbers of slots of the switches, are the same as each other. Further, each new combination T to be calculated is a combination of zero or more switches, and in each combination T, a plurality of switches of the same type are allowed to overlap. The switches with the same number of slots correspond to the same types of switches. Further, each time the process of S2-2-2 is repeated, the second calculation unit 13b calculates the new combination T in ascending order of the total number of slots of the switch included in the combination.

Next, the second calculation unit 13b of the second processing unit 13 selects one of the new combinations T calculated in S2-2-2 from (3-2) the cost value of each switch in S2-2-3. In this case, the second calculation unit 13b selects one combination T in which a total cost value that is a sum of the cost values of the switches is smallest, from among the combinations T. The second calculation unit 13b adds the one combination selected from among the combinations T to the switch combination candidate set.

By S2-2-1 to S2-2-3 being performed as described above, M combination candidates are included in the switch combination candidate set output in S2-2 and the total numbers of slots in the respective combination candidates are prime to each other. That is, the M combination candidates included in the switch combination candidate set differ in the total number of slots of the switches. Further, each combination candidate is a combination of zero or more switches, and in each combination candidate, a plurality of switches of the same type are allowed to be overlap. Each combination candidate has a candidate number. The candidate number is set to a natural number between 1 and m. When the candidate number is greater, the total number of slots of the switch included in the combination increases.

In the embodiment, a switch combination candidate set is calculated using the procedure of S2-2 described above. The switch combination candidate set calculated in S2-2 is used as an input of S3.

Calculation of Optimal Network Configuration (S3)

In calculation of the optimal network configuration (S3), the calculation unit 14a of the third processing unit 14 solves the optimization problem for minimizing the objective function. In this case, the calculation unit 14a uses a variable indicating which path candidate has been selected from the path candidate set, a variable indicating which combination candidate has been selected from the switch combination candidate set disposed at each of the communication hubs, and a variable indicating which combination candidate has been selected from the interface candidate set disposed on each link portion of each switch, as decision variables. The variable indicating which path candidate has been selected from the path candidate set is set for each of the lines. Further, the variable indicating which combination candidate has been selected from the switch combination candidate set is set for each of the communication hubs. Further, the variable indicating which combination candidate has been selected from the interface combination candidate set is set for each link. Further, the calculation unit 14a uses a relationship for deriving a total cost value of the infrastructure network as an objective function. The total cost value of the infrastructure network is a sum of a total cost value of all the switches and a total cost value of all the interfaces. A mathematical relationship obtained by formulating the optimization problem described above is shown below.

$$\begin{matrix}[ Math . 3 ] & \\ {arg min}_{\vec{x} , \vec{y} , \vec{z}} 2 {\sum }_{e ∈ E} {\sum }_{j ∈ J} {y}_{j}^{e} \cdot {Ω}_{j}^{IF} + {\sum }_{l ∈ L} {\sum }_{k ∈ K} {z}_{k}^{l} \cdot {Ω}_{k}^{TE} \\ subject to , & ( 1 ) \\ \begin{matrix}{\sum }_{i ∈ {I}^{v}} {x}_{i}^{v} = 1 , & ∀ v ∈ V\end{matrix} & ( 2 ) \\ \begin{matrix}{\sum }_{j ∈ J} {y}_{j}^{e} = 1 , & ∀ e ∈ E\end{matrix} & ( 3 ) \\ \begin{matrix}{\sum }_{k ∈ K} {z}_{k}^{l} = 1 , & ∀ l ∈ L\end{matrix} & ( 4 ) \\ \begin{matrix}{y}_{j}^{e} \cdot {Ψ}_{j}^{IF} \geq {t}^{e} ( \vec{x} , \vec{d} , M ) & ∀ e ∈ E\end{matrix} & ( 5 ) \\ \begin{matrix}{z}_{k}^{l} \cdot {Ψ}_{k}^{TE} \geq {n}^{l} ( {y}_{j}^{e} , {Ψ}_{j}^{IF} , M ) & ∀ l ∈ L\end{matrix} & ( 6 )\end{matrix}$$

Further, matters indicated by, for example, parameters relevant to the relationship (1) to (6) are as follows.

[Math. 4]

L=(l): Set of Communication hubs
E=(e): Set of Links between Communication hubs
V=(v): Set of lines
\vec{x}=(xᵢ^{v}): Line v selects path candidate i
\vec{y}=(yⱼ^{e}): Link e selects IF combination candidate j
\vec{z}=(zₖ^{l}): Communication hub 1 selects transfer apparatus (TE) combination candidate k
Ωⱼ^{IF}: Cost value of IF combination candidate j
Ωₖ^{TE}: Cost value of TE combination candidate k
I^{v}: Path candidate set of line v
J: IF Combination candidate set
K: TE Combination candidate set
Ψⱼ^{IF}: Capacity of IF combination candidate j
Ψₖ^{TE}: Number of slots of TE combination candidate k
\vec{d}=(dᵥ): Contracted band of line v
M: Connection Matrix (indicated by |L| X |E|) indicating connection form between communication hubs
t^{e}(\vec{x}, \vec{d}, M): Sum of contracted Bands of Link e (calculated on basis of \vec{x}, \vec{d}, M)
n^{l}(yⱼ^{e}, Ψⱼ^{IF}, M): Number of IFs at communication hubs 1 (calculated on basis of yⱼ^{e}, ΨHd j^{IF}, M)

In the optimization problem of S3, conditions for selecting one path candidate in each of the lines are provided as a constraint. This constraint is shown in the relationship (2). Here, in the relationship (1) to (6), a candidate number of the combination candidate selected from a path candidate set I for each of the lines is denoted with “i”. A variable x is a decision variable of the optimization problem. The variable x indicates a path candidate i selected as a path to be accommodated from the path candidate set I in a line v. That is, in each of the lines, the variable x changes in correspondence to which path candidate has been selected from the path candidate set I.

Further, in the optimization problem of S3, conditions for selecting one interface combination candidate are provided as constraints in each link. This constraint is shown in the relationship (3). Here, in the relationship (1) to (6), for each link, a candidate number of a combination candidate selected from an interface combination candidate set J is denoted with “j”. The variable y is a decision variable of the optimization problem. The variable y indicates the combination candidate j selected from the interface combination candidate set j in a link e. That is, in each link, the variable y changes in correspondence to which combination candidate has been selected from the interface candidate set J.

Further, in the optimization problem of S3, conditions for selecting one switch combination candidate are provided as constraints at each of the communication hubs. This constraint is shown in the relationship (4). Here, in the relationship (1) to (6), for each of the communication hubs, a candidate number of the combination candidate selected from a switch combination candidate set K is denoted with “k”. A variable z is a decision variable of the optimization problem. The variable z indicates a combination candidate k selected from the switch combination candidate set K at the communication hub 1. That is, at each of the communication hubs, the variable z changes in correspondence to which combination candidate has been selected from the switch combination candidate set K.

Further, in the optimization problem of S3, the capacity conditions are provided as constraints in each link. The capacity conditions are conditions in which the total contracted band does not exceed the total capacity of the interface. This constraint is shown in the relationship (5). Here, in the relationship (1) to (6), a variable Ψⱼ^{IF} indicates a total capacity of the interface per link e when the interface combination candidate with the candidate number of “j” has been selected. Further, a variable d indicates the contracted band of the line v. Further, a variable te indicates a sum of the contracted bands per link e. The variable te is calculated on the basis of the variable x, the variable d, and a connection matrix M.

Further, in the optimization problem of S3, slot conditions are provided as constraints at each of the communication hubs. The slot conditions are conditions in which the number of slots necessary for accommodation of all interfaces does not exceed the total number of slots of the switch. For example, when only one interface accommodated per slot is used, the number of slots necessary for accommodation of all interfaces to be disposed is the total number of interfaces to be disposed. This constraint is shown in the relationship (6). Here, in the relationship (1) to (6), the variable Ψₖ^{TE} indicates the number of slots of the switch per communication hub 1 when the switch combination candidate with the candidate number of “k” has been selected. Further, a variable n¹ indicates a total number of interfaces at the communication hub 1. The variable n¹ is calculated on the basis of the variable y, the variable Ψⱼ^{IF}, and the connection matrix M.

Further, in the optimization problem of S3, the objective function is used as the total cost value of the overall infrastructure network. The total cost value of the overall infrastructure network is a sum of the total cost values of all the interfaces and the total cost values of all the switches. The objective function is shown in the relationship (1). The objective function of the relationship (1) is calculated on the basis of the selected path candidate, interface combination candidate, and switch combination candidate.

In the objective function of the relationship (1), Ωⱼ^{IF} indicates a total cost value of the interfaces per link e when an interface combination candidate with a candidate number of “j” has been selected in the link number “e”. Further, in the objective function of the relationship (1), Ωₖ^{TE} indicates a total cost value of the switch per communication hub 1 when a switch combination candidate with a candidate number of “k” is selected in the communication hub number “1”.

In S3, a path candidate i is selected for each of the lines from the path candidate set I. Further, an interface combination candidate j is selected for each link from the interface combination candidate set J. Further, a switch combination candidate k is selected for each of the communication hubs from the switch combination candidate set K.

Then, in S3, a sum of total cost values of all the interfaces in the infrastructure network is calculated, as shown in the relationship (1). In calculation of a sum of the total cost value Ωⱼ^{IF} of all the interfaces, the total cost value Ωⱼ^{IF} of the interface combination candidate is first calculated for each link. A sum of the total cost values of all the links is calculated, and the calculated sum is doubled. Here, doubling the sum is because each interface included in the selected interface combination candidate is connected to each of both ends of each link.

Further, in S3, a sum of total cost values of all the switches in the infrastructure network is calculated, as shown in the relationship (1). In calculation of a sum of total cost values of all the switches, a total cost value Ωₖ^{TE} included in the switch combination candidates is first calculated for each of the communication hubs. A sum of the total cost values of all the communication hubs is calculated.

A total cost value of the infrastructure network including a sum of the calculated total cost values Ωⱼ^{IF} of the interfaces and a sum of the calculated total cost values Ωₖ^{TE} of the switches is calculated.

In S3, the total cost value of the infrastructure network is used as an objective function, as shown in the relationship (1). The optimization problem for minimizing the objective function is solved.

By solving the optimization problem described above, path candidates of each of the lines, interface combination candidates of each link, and switch combination candidates of each of the communication hubs, which minimize the sum of the cost values of the overall infrastructure network are derived. That is, an optimal decision variable x in each of the lines, an optimal decision variable y in each link, and an optimal decision variable z in each of the communication hubs are derived. The derived path candidates of each of the lines are optimal path candidates of each of the lines. Further, the derived interface combination candidates of each link are used as optimal interface combination candidate of each link. The derived combination candidates of the switches at each of the communication hubs are optimal switch combination candidates at each of the communication hubs.

As described above, the calculation unit 14a of the third processing unit 14 solves the optimization problem to calculate the optimal path candidates of each of the lines, the optimal interface combination candidate of the link portion at each communication hub, and the optimal switch combination candidate at each communication hub. The third processing unit 14 outputs the calculated optimal path candidate, optimal interface combination candidate, and optimal switch combination candidate to the output unit 15.

The optimal path candidate, the optimal interface combination candidate, and the optimal switch combination candidate for minimizing the total cost value of the overall infrastructure network are determined by S3 being performed. Thus, in the optimization problem, selection of the switch combination candidate can be used as a decision variable.

Further, in S3, in the optimization problem, the total cost value of the overall infrastructure network is used as an objective function. The total cost value of the infrastructure network is a sum of the sum of the total cost values of the interfaces and the sum of the total cost values of the switches. Thus, in the optimization problem, the objective function taking the cost of the switch into account can be set.

Further, in S3, the total number of interfaces at each communication hub is calculated from the path candidates of each of the lines and the interface combination candidates of each link, and a combination candidate of switches at each communication hub is derived on the basis of the calculated total number of interfaces at each communication hub. In this case, combination candidates of the switches at each communication hub are derived so that the conditions described above regarding the capacity of the slots of the switch are satisfied. Thereby, an appropriate network configuration is derived.

### Operational Example

An operation example in the first embodiment divided into an example of input information and an operation example of each process will be described.

Example of Input Information

Topology Information

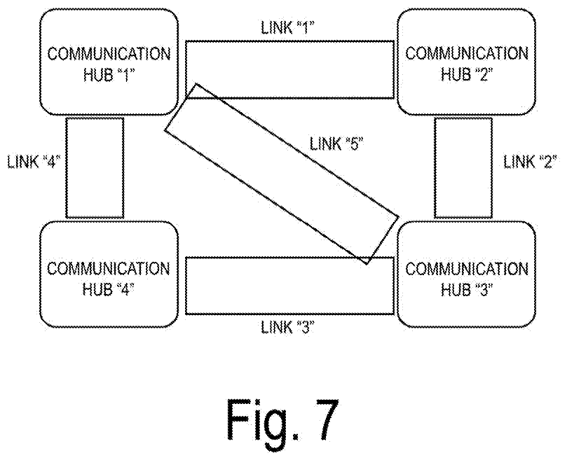

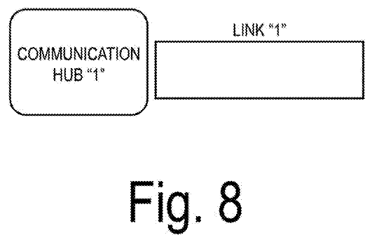

FIG. 7 is a diagram illustrating an example of the topology. FIG. 8 is a diagram illustrating a model example for use in the example of the topology in FIG. 7. That is, FIG. 8 is a diagram illustrating, for example, symbols used in the example in FIG. 7. In FIG. 8, communication hub “1” indicates a communication hub with the communication hub number of 1. Further, in FIG. 8, link “1” indicates a link with a link number of 1 and is connected to communication hub “1”.

FIG. 7 illustrates a connection state between communication hubs. Specifically, a connection state of communication hubs corresponding to communication hubs “1” to “4” via link “1” to link “5” is shown. The connection matrix M indicating the connection state between the communication hubs in the example of FIG. 7 is shown in the relationship (A) below.

$$\begin{matrix}[ Math . 5 ] & \\ M = ( \begin{matrix}1 & 0 & 0 & 1 & 1 \\ 1 & 1 & 0 & 0 & 0 \\ 0 & 1 & 1 & 0 & 1 \\ 0 & 0 & 1 & 1 & 0\end{matrix} ) & ( A )\end{matrix}$$

In the connection matrix M, each row corresponds to a communication hub, and each column corresponds to a link. When the link is connected to the communication hub, “1” is stored in a corresponding portion of the connection matrix M. On the other hand, when the link is not connected to the communication hub, “0” is stored in the corresponding portion of the connection matrix M.

Further, an example of the delay time in each link is shown as the topology information in Table 1 below. In Table 1, a delay time between the communication hubs is shown.

TABLE 1

| Link No. | Delay time |
|---|---|
| 1 | 2 |
| 2 | 1 |
| 3 | 2 |
| 4 | 1 |
| 5 | 4 |

Line Information

Next, an example of information on the line accommodated in the network is shown in Table 2 below.

TABLE 2

| | Communication | | Tolerance of inter- |
|---|---|---|---|
| Line No. | hub pair | Contracted band | end delay |
| 1 | 1, 3 | 10 | 1 |
| 2 | 1, 3 | 10 | 1 |
| 3 | 1, 3 | 10 | 0 |
| 4 | 1, 3 | 10 | 0 |

In an example of Table 2, in line “1” with the line number of “1”, communication of a contracted band “10” is performed between communication hub “1” and communication hub “3”. Line “1” has the tolerance of the inter-end delay of “0”. Here, in the example of Table 2, the tolerance of the inter-end delay is set to a value of 0 or 1. In this example, when the tolerance of the inter-end delay is 1, the tolerance is determined to be high, and a delay time of twice the inter-end delay of the shortest path is set as the upper limit delay value. On the other hand, when the tolerance of the inter-end delay is 0, the tolerance is determined to be low, and the inter-end delay of the shortest path is set as the upper limit delay value.

Apparatus Information

Next, an example of information on a switch that is a transfer apparatus (network apparatus) disposed at the communication hub and an interface (link portion apparatus) installed in the link portion of the switch will be described.

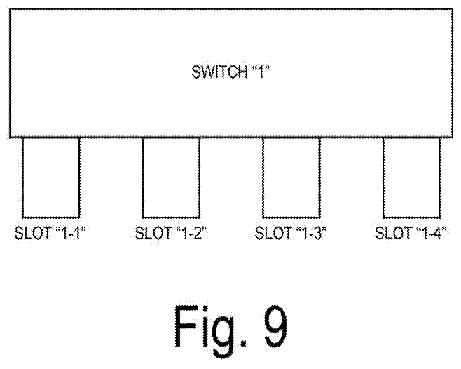

FIG. 9 illustrates an example of the switch. The switch in the example of FIG. 9 is a switch “1” with a switch number “1” and includes a slot “1-1”, a slot “1-2”, a slot “1-3”, and a slot “1-4”. The switch “1” receives data in which a destination is indicated. The switch “1” determines a slot to output the data on the basis of the destination indicated in the data. Accordingly, a link that outputs the data is determined.

The slot corresponds to a connection portion (link connection portion) between a communication hub and the link. Further, the slot accommodates an interface.

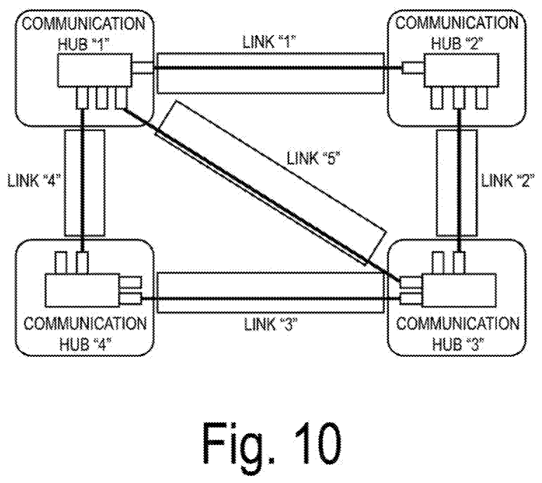

FIG. 10 illustrates an example of disposition of switches in the infrastructure network illustrated in FIG. 7. Thus, in FIG. 10, an example of a method of connecting switches in the topology of FIG. 7 is shown. In an example of FIG. 10, a switch is installed in communication hubs “1” to “4”. The slots of each switch are connected by a cable via a link, and the respective communication hubs are connected.

Next, an example of information on the switch is shown in Table 3 below.

TABLE 3

| | Number | | Traffic capacity |
|---|---|---|---|
| Transfer apparatus | of slots | Cost value | per slot |
| Switch “1” | 4 | 1 | 100 Gbit/s |
| Switch “2” | 8 | 2 | 100 Gbit/s |
| Switch “3” | 16 | 4 | 100 Gbit/s |

In an example of Table 3, information on switches with switch numbers of “1” to “3” is shown. In the example of Table 3, switch “1” with the switch number of “1” includes four slots. Further, in switch “1”, a total amount of traffic capacity that can be processed is 400 Gbit/s because a traffic capacity per slot is 100 Gbit/s. The total amount of traffic capacity is a sum of the traffic capacities of the slots provided in the switch. Switch “1” has a cost value of 1.

Further, an example of information on the interface is shown in Table 4 below.

TABLE 4

| Link portion apparatus | Traffic Capacity | Cost value | Capacity |
|---|---|---|---|
| Interface “1” | 10 Gbit/s | 1 | 1 per slot |
| Interface “2” | 40 Gbit/s | 3 | 1 per slot |
| Interface “3” | 100 Gbit/s | 5 | 1 per slot |

In the example of Table 4, information on interfaces with interface numbers of “1” to “3” is shown. In the example of Table 4, in interface “1” with the interface number of “1”, a traffic capacity that can be processed is 10 Gbit/s. One interface “1” can be installed in one slot and has a cost value of 1.

Design Parameter Information

An example of the design parameter information is shown in Table 5 below. In the example of Table 5, the design parameter information includes the number of path candidates per line (an upper limit value of the number of path candidates), the number of switch combination candidates (a design value of the number of switch combination candidates), and the number of interface combination candidates (a design value of the number of interface combination candidates).

TABLE 5

| | |
|---|---|
| Number of path candidates per line | 3 |
| Number of switch combination candidates | 10 |
| Number of interface combination candidates | 10 |

Example of Operation of Each Process

Calculation of Path Candidate Set (S1)

First, in S1-1, a minimum inter-end delay of each of the lines is calculated. Table 6 below shows an example of a minimum inter-end delay of each of the lines. In Table 6, for example, a minimum inter-end delay when the input information described above in the operation example has been input is shown.

TABLE 6

| | | Minimum |
|---|---|---|
| Line No. | Communication hub pair | inter-end delay |
| 1 | 1, 3 | 3 |
| 2 | 1, 3 | 3 |
| 3 | 1, 3 | 3 |
| 4 | 1, 3 | 3 |

In an example of Table 6, in a communication hub pair of communication hub “1” and communication hub “3”, the inter-end delay has a minimum value in a path passing through link “1”, communication hub “2”, and link “2” and a path passing through link “4”, communication hub “4”, and link “3”. Thus, the inter-end delay in the path passing through link “1”, communication hub “2”, and link “2” or the inter-end delay in the path passing through link “4”, communication hub “4”, and link “3” is set as the minimum inter-end delay. From Table 1 described above, the delay time of link “1” is 2, and the delay time of link “2” is 1. Thus, the inter-end delay in the path passing through link “1”, communication hub “2”, and link “2” becomes “2+1=3”. Each line has a communication hub pair of communication hub “1” and communication hub “3”. Thus, in each of the lines, the minimum inter-end delay is “3”.

Next, in S1-2, the upper limit delay value of each of the lines is calculated. Table 7 below shows an example of the upper limit delay value of each of the lines. In Table 7, for example, the upper limit delay value when the input information described above in the operation example is input and the minimum inter-end delay is calculated as in Table 6 of the operation example is shown.

TABLE 7

| | Communication | Tolerance of | Minimum inter- | Upper limit |
|---|---|---|---|---|
| Line No. | hub pair | inter-end delay | end delay | delay value |
| 1 | 1, 3 | 1 | 3 | 6 |
| 2 | 1, 3 | 1 | 3 | 6 |
| 3 | 1, 3 | 0 | 3 | 3 |
| 4 | 1, 3 | 0 | 3 | 3 |

In an example of Table 7, line “1” and line “2” with the tolerance of the inter-end delay of 1 are determined to be high in the tolerance. Thus, in line “1” and line “2”, a delay time twice the minimum inter-end delay is set as the upper limit delay value, and the upper limit delay value is 6. On the other hand, line “3” and line “4” with the tolerance of the inter-end delay of 0 are determined to below in the tolerance. Thus, inline “3” and line “4”, the minimum inter-end delay is set as the upper limit delay value, and the upper limit delay value is 3.

Next, in S1-3 to S1-6, path candidates in each of the lines are calculated. When input information indicating an example of the input information is input, the path candidates are calculated on the basis of the number of path candidates of 3 per line set in Table 5. Thus, in each of the lines, a maximum of three path candidates are calculated. Table 8 below shows an example of path candidates of each of the lines to be calculated, and shows an example of the path candidate set. In Table 8, for example, the path candidate set when the input information described above is input in the operation example and the upper limit delay value is calculated as in Table 7 of the operation example is shown.

TABLE 8

| | upper limit | Path | |
|---|---|---|---|
| Line No. | delay value | candidate | Use link |
| 1 | 6 | 1-1 | Link “1”, link “2” |
| | | 1-2 | Link “3”, link “4” |
| | | 1-3 | Link “5” |
| 2 | 6 | 2-1 | Link “1”, link “2” |
| | | 2-2 | Link “3”, link “4” |
| | | 2-3 | Link “5” |
| 3 | 3 | 3-1 | Link “1”, link “2” |
| | | 3-2 | Link “3”, link “4” |
| | | 3-3 | — |
| 4 | 3 | 4-1 | Link “1”, link “2” |
| | | 4-2 | Link “3”, link “4” |
| | | 4-3 | — |

In an example of Table 8, line “1” has an upper limit delay value of “6”. Thus, in line “1”, path “1-1” and “1-2” with the inter-end delay of “3” and path “1-3” with the inter-end delay of “4” are path candidates. On the other hand, line “3” has the upper limit delay value of “3”. Thus, in line “3”, only paths “3-1” and “3-2” with the inter-end delay of “3” are path candidates.

Calculation of interface combination candidate set (S2-1) Table 9 below shows an example of an interface combination candidate set to be calculated. In Table 9, for example, the interface combination candidate set when the input information described above is input in the operation example is shown.

TABLE 9

| Candidate No. | | | |
|---|---|---|---|
| of interface | | | Total |
| combination | | Total | cost |
| candidate | Combination | Capacity | value |
| 1 | — | 0 | 0 |
| 2 | Interface “1” | 10 | 1 |
| 3 | Interface “1” * 2 | 20 | 2 |
| 4 | Interface “1” * 3 | 30 | 3 |
| 5 | Interface “2” | 40 | 3 |
| 6 | Interface “2”, interface “1” * 1 | 50 | 4 |
| 7 | Interface “2”, interface “1” * 2 | 60 | 5 |
| 8 | Interface “2”, interface “1” * 3 | 70 | 6 |
| 9 | Interface “2” * 2 | 80 | 6 |
| 10 | Interface “2” * 2, interface | 90 | 7 |
| | “1” * 1 | | |

In the calculation of the interface combination candidate set, one or more new combinations of interfaces are calculated each time S2-1-2 is repeated. In S2-1-2, a total capacity of interfaces included in the new combination to be calculated is different each time, and a new combination is calculated in ascending order of the total capacity each time the process of S2-1-2 is repeated. Thus, in S2-1-2, the interfaces included in the new combination to be calculated form different combinations each time.

For example, a case in which combinations of interfaces with a total capacity of “40 Gbit/s” are calculated in S2-1-2 will be described. In this case, a combination in which four interfaces with a capacity of “10 Gbit/s” are included, and a combination in which one interface with a capacity of “40 Gbit/s” is included are calculated as the combinations of interfaces with a total capacity of “40 Gbit/s”.

In S2-1-3, the total cost value of the combination calculated in S2-1-2 is calculated. Here, the total cost value of the combination in which four interfaces with a capacity of “10 Gbit/s” are included is “1*4=4”, and the total cost value of the combination in which one interface with a capacity of “40 Gbit/s” is included is “3*1=3”. That is, the combination in which one interface with a capacity of “40 Gbit/s” is included among the combinations calculated in S2-1-2 has the smallest total cost value. Thus, in S2-1-3, a combination including one interface with a capacity of “40 Gbit/s” is added to the interface combination candidate set as a combination candidate.

When the input information described above in the operation example has been input, the process of S2-1-1 is performed on the basis of the number of interface combination candidates of 10 set in Table 5. That is, in S2-1-1, it is determined whether the number of calculated combination candidates is smaller than 10. Accordingly, ten combination candidates with different total capacities are calculated for the combination of interfaces. Further, candidate numbers “1” to “10” are set for the combination candidates.

Calculation of Switch Combination Candidate Set (S2-2)

Table 10 below shows an example of a switch combination candidate set to be calculated. In Table 10, for example, a switch combination candidate set when the input information described above in the operation example has been input is shown.

TABLE 10

| Candidate No. of | | Total | Total |
|---|---|---|---|
| switch combination | | number of | cost |
| candidate | Combination | slots | value |
| 1 | — | 0 | 0 |
| 2 | Switch “1” | 4 | 1 |
| 3 | Switch “2” | 8 | 2 |
| 4 | Switch “1”, switch “2” | 12 | 3 |
| 5 | Switch “3” | 16 | 4 |
| 6 | Switch “3”, switch “1” | 20 | 5 |
| 7 | Switch “3”, switch “2” | 24 | 6 |
| 8 | Switch “3”, switch “2”, switch “1” | 28 | 7 |
| 9 | Switch “3” * 2 | 32 | 8 |
| 10 | Switch “3” * 2, switch “1” | 36 | 9 |

In the calculation of the switch combination candidate set, one or more new combinations of switches are calculated each time S2-2-2 is repeated. In S2-2-2, the total number of slots of the switch included in the new combination to be calculated is different each time, and a new combination is calculated in ascending order of the total number of slots each time the process of S2-2-2 is repeated. Thus, in S2-2-2, the switches included in the new combination to be calculated form different combinations each time.

For example, a case in which combinations of switches with a total number of slots of “16” are calculated in S2-2-2 will be described. In this case, as the combinations of switches with the total number of slots of “16”, a combination in which four switches with the number of slots of “4” are included, a combination in which two switches with the number of slots of “4” and one switch with the number of slots of “8” are included, and a combination in which one switch with the number of slots of “16” is included are calculated.

Here, among the combinations calculated in S2-2-2, the combination in which one switch with the number of slots of “16” is included includes the smallest number of switches. Thus, in S2-2-3, the combination in which one switch with the number of slots of “16” is included is added to the switch combination candidate set as a combination candidate.

When the input information described above in the operation example has been input, the process of S2-2-1 is performed on the basis of the number of switch combination candidates of 10 set in Table 5. That is, in S2-2-1, it is determined whether the number of calculated combination candidates is smaller than 10. Accordingly, ten combination candidates with the different total numbers of slots are calculated for the combination of switches. Further, candidate numbers “1” to “10” are set for the combination candidates.

Calculation of Optimal Network Configuration (S3)

In S3, the optimization problem described above is solved. Table 11 illustrates an example of the optimal path candidates of each of the lines calculated in the optimization problem. For example, in the operation example, when S1 and S2 have been performed as described above, the optimal path candidates of each of the lines are calculated as in Table 11. Table 12 illustrates an example of the optimal interface combination candidates of each link calculated in the optimization problem. For example, in the operation example, when S1 and S2 have been performed as described above, the optimal interface combination candidates of each link are calculated as in Table 12. Table 13 illustrates an example of optimal switch combination candidates at each communication hub calculated in the optimization problem. For example, in the operation example, when S1 and S2 have been performed as described above, the optimal switch combination candidates at each communication hub are calculated as in Table 13.

TABLE 11

| Line No. | No. of selected path candidate |
|---|---|
| 1 | 1-1 |
| 2 | 2-1 |
| 3 | 3-1 |
| 4 | 4-1 |

TABLE 12

| | Candidate No. of selected |
|---|---|
| Link No. | interface combination candidate |
| 1 | 5 |
| 2 | 5 |
| 3 | 1 |
| 4 | 1 |
| 5 | 1 |

TABLE 13

| | Candidate No. of selected |
|---|---|
| Communication hub No. | switch combination candidate |
| 1 | 2 |
| 2 | 2 |
| 3 | 2 |
| 4 | 1 |

That is, when S1 and S2 have been performed as described above in the operation example, path “1-1” is calculated as the optimal path candidate for line “1”, path “2-1” is calculated as the optimal path candidate for line “2”, path “3-1” is calculated as the optimal path candidate for line “3”, and path “4-1” is calculated as the optimal path candidate for line “4.”

Further, in S3, a total contracted band te for each link is calculated on the basis of the selected path candidates of each of the lines. In the example of Table 11, a path candidate using link “1” and link “2” is calculated as an optimal path in lines “1” to “4”. Thus, for example, four lines with the contracted band of “10 Gbit/s” are accommodated in link “1” and link “2”. Thus, in link “1” and link “2”, a total contracted band is “10+10+10+10=40 Gbit/s”. Further, lines are not accommodated in link “3”, link “4”, and link “5”. Thus, a total contracted band of link “3”, link “4”, and link “5” is “0”.

Further, as shown in Table 12, when S1 and S2 have been performed as described above in the operation example, the combination candidate with the candidate number of “5” is calculated as an optimal interface combination candidate for links “1” and “2”, and the combination candidate “1” is calculated as an optimal interface combination candidate for links “3” to “5”. As shown in the relationship (5), a total capacity of the interface in the calculated combination candidate in each link is equal to or greater than the total contracted band.

In link “1”, the combination candidate with the candidate number of “5” is calculated as the optimal interface combination candidate. Thus, one interface “2” is installed in each link portion to which link “1” is connected. Thus, one interface “2” is installed in each link portion corresponding to link “1” at communication hub “1” and communication hub “2”.

Similarly, because the combination candidate with the candidate number of “5” is calculated as the optimal interface combination candidate in link “2”, one interface “2” is installed in each link portion corresponding to link “1” at communication hub “2” and communication hub “3”.

Further, in links “3” to “5”, the combination candidate with the candidate number of “1” is calculated as the optimal interface combination candidate. Thus, no interface is installed in the link portion to which links “3” to “5” are connected.

Accordingly, a total of four interfaces “2” with a cost value of 3 are installed on the infrastructure network including links “1” to “5”. Thus, a sum of the cost values of all the interfaces on the infrastructure network is “2*(3+3+0+0+0)=12”.

Further, in S3, the total number of interfaces is calculated for each communication hub on the basis of the selected path candidates of each of the lines and the selected combination candidates of the interfaces of each link.

In the examples of Tables 11 and 12, for example, one interface “2” is installed in each link corresponding to link “1” at communication hub “1”. One interface “2” is accommodated per slot of the switch. Thus, at communication hub “1”, a total number of interfaces to be installed is “1”, and the number of slots required to accommodate the interfaces to be installed is “1”.

Further, for example, at communication hub “2”, one interface “2” is installed in the link portion corresponding to link “1”, and one interface “2” is installed in the link portion corresponding to link “2”. One interface “2” is accommodated per slot of the switch. Thus, at communication hub “2”, a total number of interfaces to be installed is “2”, and the number of slots required to accommodate the interfaces to be installed is “2”.

Similarly, at communication hubs “3” to “4”, a total number of interfaces to be installed is also calculated on the basis of the interfaces installed in the corresponding link portion.

Further, when S1 and S2 have been performed as described above in the operation example, combination candidate “2” is calculated as the optimal switch combination candidate for communication hubs “1” to “3”, and combination candidate “1” is calculated as the optimal switch combination candidate for communication hub “4”, as shown in Table 13. Because a combination of candidate numbers “2” is calculated at communication hubs “1” to “3”, one switch “1” with the number of slots of “4” is disposed. Thus, at communication hubs “1” to “3”, a total number of slots of the switch to be disposed is “4” and is equal to or greater than the total number of interfaces to be installed. That is, at communication hubs “1” to “3”, the total number of slots in the switch to be disposed is equal to or greater than the number of slots required to accommodate the interfaces to be installed.

Further, because the combination with the candidate number of “1” is selected at communication hub “4”, the switch is not disposed. At communication hub “4”, the total number of slots of the switch to be disposed is equal to or greater than the total number of interfaces to be installed, that is, the number of slots required to accommodate the interfaces to be installed.

At communication hubs “1” to “3”, because one switch “1” with a cost value of “1” is disposed, the total cost value of the switch to be installed is 1. At communication hub “4”, because no switch is disposed, the total cost value of the switch to be installed is 0. Thus, a sum of the total cost values of all the switches on the infrastructure network including communication hubs “1” to “4” is “1+1+1+0=3”.

As described above, in the operation example, a sum of the total cost values of all the interfaces is “12”, and a sum of the total cost values of all the switches is “3” in the overall infrastructure network. Thus, the total cost value of the overall infrastructure network is “12+3=15”, which is a minimum value.

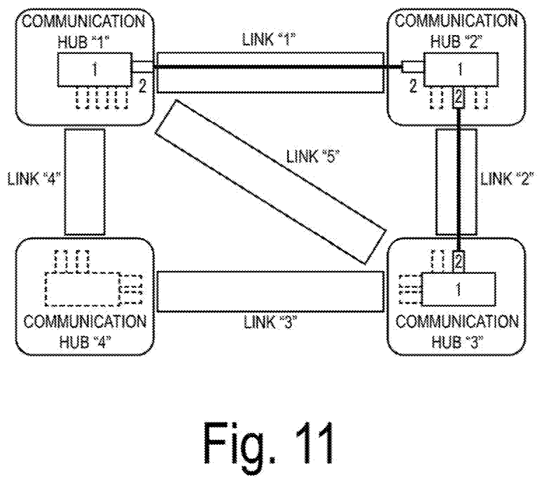

An optimal network configuration, that is, an optimal disposition example in the network is generated and output on the basis of the optimal path candidates of each of the lines, the optimal interface combination candidate of each link, and the optimal switch combination candidates at each communication hub derived as described above. FIG. 11 illustrates an example of an optimal disposition in a network. FIG. 11 illustrates a disposition example when the optimal path candidates of each of the lines have been calculated as in Table 11, the optimal interface combination candidates of each link have been calculated as in Table 12, and the optimal switch combination candidates at each communication hub have been calculated as in Table 13.

In the optimal disposition example illustrated in FIG. 11, a switch (transfer apparatus) is disposed only in communication hubs “1” to “3”, and a switch (transfer apparatus) is not disposed at communication hub “4”. In each of communication hubs “1” to “3”, an interface of a type of interface “2” is installed only in the link portions of link “1” and link “2”. An interface is not installed in the link portions of links “3” to “5”.

Operations and Effects

In the embodiment, the total cost value of the switch is taken into account, in addition to the total cost value of the interface. Thus, it is possible to derive an optimal network configuration capable of reducing the total cost value of the overall infrastructure network, as compared to a case in which only the total cost value of the interface is taken into account.

Here, in the calculation of the optimal network configuration, a comparative example in which only the cost value of the interfaces is taken into account as the total cost value of the overall infrastructure network. As in the operation example described above, it is assumed that there are four lines and five links in the network infrastructure.

In the comparative example, in the calculation of the optimal network configuration, it is assumed that only a variable indicating the path candidate selected in each of the lines and a variable indicating the interface combination candidate selected in each link are decision variables of the optimization problem. Further, only a sum of the total cost values of all the interfaces is used as the objective function. Thus, in the comparative example, a variable indicating the switch combination candidate selected at each communication hub is not used as the decision variable. Further, a sum of the total cost values of all the switches is not included in the objective function, and slot conditions of the switch are not provided as constraints. In the comparative example, the optimization problem is solved, as in S′3 of NPL 1.

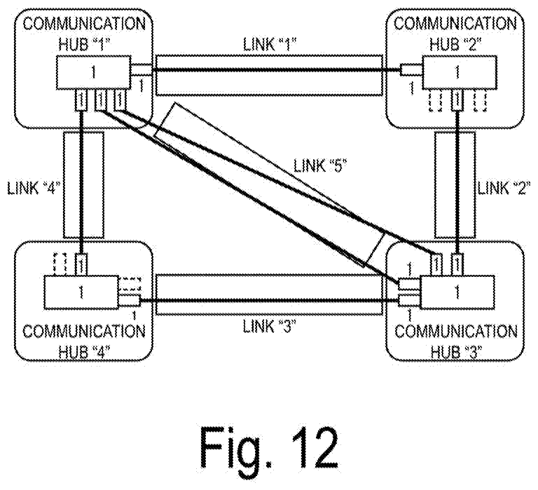

Table 14 shows an example of the optimal path candidates of each of the lines that is calculated in the optimization problem in the comparative example. Table 15 shows an example of the optimal interface combination candidate of each link that is calculated in the optimization problem in the comparative example. Table 16 shows an example of the optimal switch combination candidate at each communication hub that is calculated in the optimization problem in the comparative example. FIG. 12 shows a disposition example when the optimal path candidates of each of the lines are calculated as in Table 14, the optimal interface combination candidate of each link are calculated as in Table 15, and the optimal switch combination candidates at each communication hub are calculated as in Table 16.

TABLE 14

| Line No. | No. of selected path candidate |
|---|---|
| 1 | 1-3 |
| 2 | 2-3 |
| 3 | 3-1 |
| 4 | 4-2 |

TABLE 15

| | Candidate No. of selected |
|---|---|
| Link No. | interface combination candidate |
| 1 | 2 |
| 2 | 2 |
| 3 | 2 |
| 4 | 2 |
| 5 | 3 |

TABLE 16

| | Candidate No. of selected |
|---|---|
| Communication hub No. | switch combination candidate |
| 1 | 2 |
| 2 | 2 |
| 3 | 2 |
| 4 | 2 |

In the comparative example, path “1-3” is calculated as an optimal path candidate for line “1”, path “2-3” is calculated as an optimal path candidate for line “2”, path “3-1” is calculated as an optimal path candidate for line “3”, and path “4-2” is calculated as an optimal path candidate for line “4”, as shown in Table 14.

Thus, for example, one line in which the contracted band is “10 Gbit/s” is accommodated in links “1” to “4”. Thus, in links “1” to “4”, the total contracted band is “10 Gbit/s”. Further, two lines in which the contracted band is “10 Gbit/s” are accommodated in link “5”. Thus, the total contracted band of link “5” is “10+10=20 Gbit/s”.

Further, as shown in Table 15, in the comparative example, the combination candidate with the candidate number of “2” is calculated as an optimal interface combination candidate for links “1” to “4”, and the combination candidate with the candidate number of “3” is calculated as an optimal interface combination candidate for link “5”. As shown in the relationship (4)′, a total capacity of the interface in the calculated combination candidate in each link is equal to or greater than the total contracted band.

In link “1”, the combination candidate with the candidate number of “2” is calculated as the optimal interface combination candidate. Thus, one interface “1” is installed in each of the link portions to which link “1” is connected. Accordingly, one interface “1” is installed in each link portion corresponding to link “1” at communication hub “1” and communication hub “2”.

Similarly, in links “2” to “5”, the interface is also installed in each of the link portions of the corresponding communication hub on the basis of the combination candidate calculated as the optimal interface combination candidate.

In the comparative example, a total of 12 interfaces “1” with a cost value of 1 are installed in the infrastructure network including links “1” to “5”. Thus, a sum of the cost values of all the interfaces on the infrastructure network is “1*12=12”.

Further, in the modification example, the combination candidate with a combination candidate number of “2” is calculated as the optimal switch combination candidate for communication hubs “1” to “4”, as shown in Table 16. At communication hubs “1” to “4”, because a combination with a candidate number of “2” is calculated, one switch “1” with a cost value of “1” is disposed. Accordingly, at communication hubs “1” to “4”, a total cost value of the installed switches is “1”. Thus, a sum of the total cost values of all the switches in the infrastructure network including communication hubs “1” to “4” is “1+1+1+1=4”.

As described above, in the comparative example, the total cost value of all the interface is “12” and a sum of the total cost values of all the switches is “4”. Thus, the total cost value of the overall infrastructure network is “12+4=16”.

In the optimal network conation calculated in the comparative example, the total cost value of the overall infrastructure network is greater than the total cost value of the overall infrastructure network in the network configuration calculated in the operation example of the embodiment, and is not a minimum value. That is, when only the cost value of the interface has been used as the objective function of the optimization problem as in the comparative example, a network configuration in which the total cost value of the overall infrastructure network does not have a minimum value may be derived as an optimal network configuration.

On the other hand, in the embodiment, the total cost value of the switches is taken into account as the total cost value of the overall infrastructure network, in addition to the total cost value of the interfaces. Thus, the network configuration calculated in the comparative example is not derived as an optimal network configuration because the total cost value is greater than that of the network configuration calculated in the operation example of the embodiment. Thus, in the embodiment, it is possible to guide an optimal network configuration in which the total cost value of the overall infrastructure network is reduced, by taking the total cost value of the transfer apparatus into account, in addition to the cost value of the link portion apparatus.

A scheme described in each embodiment is stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like) or transferred by a communication medium for distribution, as a program (a software means) that can be executed by a calculator (a computer). The program stored in the medium also includes a setting program for causing a software means (including not only an execution program but also a table or data structure), which will be executed in a calculator, to be configured within the calculator A calculator implementing the present apparatus executes the above-described process by loading the program recorded on the recording medium or constructing a software means using the setting program in some cases, and controlling an operation using the software means. The recording medium referred to herein is not limited to a recording medium for distribution, and includes a storage medium such as a magnetic disk or a semiconductor memory provided inside the calculator or in an apparatus connected via a network.

Further, the present invention is not limited to the embodiments, and it is possible to make various modifications without departing from the gist of the present invention. Further, the embodiments may be implemented in appropriate combination, and in this case, effects of the combination can be obtained. Further, various inventions are included in the above embodiment and can be extracted by a combination selected from a plurality of configuration requirements that are disclosed. For example, in a case in which the problem can be solved and the effects can be obtained even when some of all the configuration requirements shown in the embodiment are removed, a configuration in which such configuration requirements have been removed can be extracted as an invention.

### REFERENCE SIGNS LIST

10 Network design apparatus
11 Input unit
12 First processing unit
12a Calculation unit
13 Second processing unit
13a First calculation unit
13b Second calculation unit
14 Third processing unit
14a Calculation unit
15 Output unit

1. A network design apparatus for designing a network configuration for a network in which a transfer apparatus is disposed for each of a plurality of communication hubs and the communication hubs are connected via a link by a link portion apparatus in the transfer apparatus, the network design apparatus comprising:
an input reception unit configured to receive an input of topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
a first processing unit including a calculation unit configured to calculate a path candidate set of each of the lines on the basis of the topology information, the line information, and the design parameter information;
a second processing unit including a first calculation unit configured to calculate a combination candidate set of the link portion apparatuses on the basis of the apparatus information and the design parameter information, and a second calculation unit configured to calculate a combination candidate set of the transfer apparatuses on the basis of the apparatus information and the design parameter information;
a third processing unit including a calculation unit configured to calculate, minimizing a total cost value in the overall network, an optimal path candidate of each of the lines, an optimal combination candidate of the link portion apparatus of each of the links, and an optimal combination candidate of the transfer apparatus at each of the communication hubs on the basis of a calculation result of the calculation unit of the first processing unit, a calculation result of the first calculation unit of the second processing unit, and a calculation result of the second calculation unit of the second processing unit; and
a generation unit configured to generate network configuration information reflecting the optimal path candidate of each of the lines, the optimal combination candidate of the link portion apparatus of each of the links, and the optimal combination candidate of the transfer apparatus at each of the communication hubs calculated by the calculation unit of the third processing unit.

2. The network design apparatus according to claim 1, wherein the calculation unit of the third processing unit uses a sum of a total cost value of the link portion apparatuses in the overall network and a total cost value of the transfer apparatuses in the overall network as a total cost value in the overall network.

3. The network design apparatus according to claim 2,
wherein the second calculation unit of the second processing unit calculates the combination candidate set of the transfer apparatuses with a different total number of slots of the transfer apparatuses for each of the combination candidates, and
the calculation unit of the third processing unit
calculates a total number of link portion apparatuses at each of the communication hubs on the basis of the selected path candidate of each of the lines and the selected combination candidate of the link portion apparatuses for each of the links, and
calculates an optimal combination candidate of the transfer apparatuses at each of the communication hub on condition that the total number of slots of the transfer apparatus in the derived combination candidate is equal to or greater than the calculated total number of the link portion apparatuses for each of the communication hubs.

4. A non-transitory computer readable medium which stores a network design processing program for designing a network configuration for a network in which a transfer apparatus is disposed for each of a plurality of communication hubs and the communication hubs are connected via a link by a link portion apparatus in the transfer apparatus, the network design processing program causing a processor to
acquire topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
calculate a path candidate set of each of the lines on the basis of the topology information, the line information, and the design parameter information;
calculate a combination candidate set of the link portion apparatuses on the basis of the apparatus information and the design parameter information;
calculate a combination candidate set of the transfer apparatuses on the basis of the apparatus information and the design parameter information;
calculate, minimizing a total cost value in the overall network, an optimal path candidate of each of the lines, an optimal combination candidate of the link portion apparatus of each of the link, and an optimal combination candidate of the transfer apparatus at each of the communication hubs on the basis of a calculation result for the path candidate set of each of the lines, a calculation result for the combination candidate set of the link portion apparatus, and a calculation result for the combination candidate set of the transfer apparatus; and
generate network configuration information reflecting the calculated optimal path candidate of each of the lines, the calculated optimal combination candidate of the link portion apparatus of each of the links, and the calculated optimal combination candidate of the transfer apparatus at each of the communication hubs.

5. A network design method for designing a network configuration for a network in which a transfer apparatus is disposed for each of a plurality of communication hubs and the communication hubs are connected via a link by a link portion apparatus in the transfer apparatus, the network design method comprising:
acquiring topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
calculating a path candidate set of each of the lines on the basis of the topology information, the line information, and the design parameter information;
calculating a combination candidate set of the link portion apparatuses on the basis of the apparatus information and the design parameter information;
calculating a combination candidate set of the transfer apparatuses on the basis of the apparatus information and the design parameter information;
calculating, minimizing a total cost value in the overall network, an optimal path candidate of each of the lines, an optimal combination candidate of the link portion apparatus of each of the link, and an optimal combination candidate of the transfer apparatus at each of the communication hubs on the basis of a calculation result for the path candidate set of each of the lines, a calculation result for the combination candidate set of the link portion apparatus, and a calculation result for the combination candidate set of the transfer apparatus; and
generating network configuration information reflecting the calculated optimal path candidate of each of the lines, the calculated optimal combination candidate of the link portion apparatus of each of the links, and the calculated optimal combination candidate of the transfer apparatus at each of the communication hubs.
